(19) United States
(12) Patent Application Publication
(10) Pub. No.: US 2016/0371680 A1
(43) Pub. Date: Dec. 22, 2016

(54) SYSTEMS AND METHODS FOR SECURE PAYMENT

(71) Applicant: Stanley Kevin Miles, Foresthill, CA (US)

(72) Inventor: Stanley Kevin Miles, Foresthill, CA (US)

(21) Appl. No.: 15/187,469

(22) Filed: Jun. 20, 2016

Related U.S. Application Data
(60) Provisional application No. 62/182,369, filed on Jun. 19, 2015.

(51) Int. Cl. G06Q 20/36; G06Q 20/40

(52) U.S. Cl. CPC G06Q 20/3674; G06Q 20/401

(57) ABSTRACT

Systems and methods that enable a payer to perform a secure electronic financial payment transaction to a point of sale biller without the need to transmit certain sensitive information to the point of sale biller are described herein. For example, systems and methods for improving the security of computer systems used for financial payment transactions are described herein. In some embodiments, a secure pass-through server is configured to receive biller data from an authorized user payment interface device to facilitate a bill payment to a biller without requiring sensitive payment information from the authorized user payment interface device or the biller during the transaction.

### CROSS-REFERENCES

This application claims the benefit of U.S. Provisional Patent Application No. 62/182,369, filed Jun. 19, 2015, the entire contents of which are hereby incorporated by reference.

### BACKGROUND OF THE INVENTION

Field of the Invention

This application relates to systems and methods for secure payment over a computing device. More particularly, this application relates to systems and methods that enable a payer to complete a secure electronic financial payment transaction to a point of sale biller without the need to transmit certain sensitive information to the point of sale biller.

Description of the Related Technology

Currently, whenever payers make payments to billers (e.g., brick and mortar stores, government entities, service providers, online stores, web based checkout, goods providers, etc.) the payments are completed through either some form of electronic (e.g., electronic check payment, tap-to-pay from a cell phone or apple pay, etc.) or credit card or debit card based type of transaction, or in some cases for physical locations, the physical exchange of paper or coin currency or a physical check. These existing electronic or credit card based types of transactions typically require a customer to provide or send a credit card number or otherwise some form of electronic payment data to the biller's point of sale computer system of which further transmits the credit card number or payment data through one or more various payment networks to the credit card company or payment data company's payment processing computer systems seeking responsive authorization and approval for the point of sale biller to complete the payment transaction unless otherwise responsively declined. These electronic payment data or credit card based transactions may be convenient as they do not require a customer to carry currency or a checkbook. However, there are certain drawbacks to such electronic or credit card or payment data based transactions.

In any such electronic or credit card based transactions, there is a transfer of the customer's sensitive information (e.g., credit card number or otherwise some form of electronic payment data) from the customer to the biller or the biller's computer system to furthermore be transmitted through one or more various payment networks to the credit card company or payment data company's payment processing computer systems in order to ultimately complete a credit card or payment data debit transaction to fulfill a customer's payment to a point of sale biller. This can pose significant security risks. In particular, the biller's computer system may be compromised, and a third party may be able to gain access to any such transactions including the customer's sensitive information. The third party may then use the sensitive information to access the customer's financial account funds or credit lines, or make unauthorized transactions using the customer's credit card or financial institution account information. This can lead to large financial losses for the customer, the biller, and/or the credit card companies and the financial institutions they are associated with. This is especially problematic for larger billers, where a compromised biller's computer system or any of the associated networks that communicate with any credit card company or payment data company's payment processing computer systems or any associated databases thereof can result in a third party gaining access to the sensitive information of millions of customers.

Accordingly, new or modified systems and methods are needed for improving the security of performing financial payment transactions electronically, while still maintaining convenience and ease of use for customers.

### SUMMARY

In one embodiment, a system for improving security of computing devices used for financial payment transactions is provided. The system may include a memory and a processor coupled to the memory. The processor may be configured to receive, via a computing device associated with a payer, biller data associated with a biller for a transaction between the payer and the biller. The processor may be further configured to determine availability of funds in one or more accounts associated with the payer for completing the transaction based on the received biller data and receive a selection of one or more accounts having sufficient available funds to use for payment. The processor may be further configured to provide an indication of the availability of funds to both the payer and the biller and the payer may then further elect to facilitate a transfer of at least a portion of the funds to the biller to complete the transaction without the computing device of the biller receiving sensitive information from the payer regarding the one or more accounts.

### BRIEF DESCRIPTION OF THE DRAWINGS

FIG. 1A is an example of a prior art payment process reflecting certain drawbacks described above.

FIG. 1B illustrates an example of a system for making secure payments electronically.

FIG. 2 illustrates an example of an authorized user financial institution of the system of FIG. 1B.

FIG. 3 illustrates an example of a secure pass through server of the system of FIG. 1B.

FIG. 4 illustrates an example of a biller point of sale device of the system of FIG. 1B.

FIG. 5 illustrates an example of a transaction record storage of the biller point of sale device of FIG. 4.

FIG. 6 illustrates an example of a process for establishing accounts and verifications for making secure payments using the system of FIG. 1B.

FIG. 7 illustrates an example of a process for completing a transaction using the system of FIG. 1B.

FIG. 8 illustrates an example of a process for approving a transaction using the system of FIG. 1B.

FIGS. 9A-9E illustrate various payment funding scenarios according to one or more embodiments.

FIG. 10 illustrates an example of block diagram of a computing device.

### DETAILED DESCRIPTION OF CERTAIN INVENTIVE EMBODIMENTS

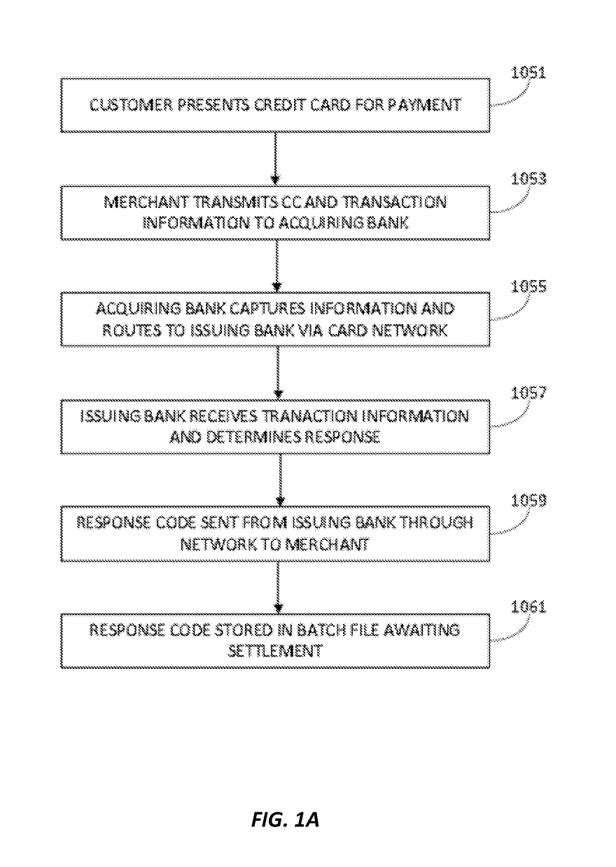

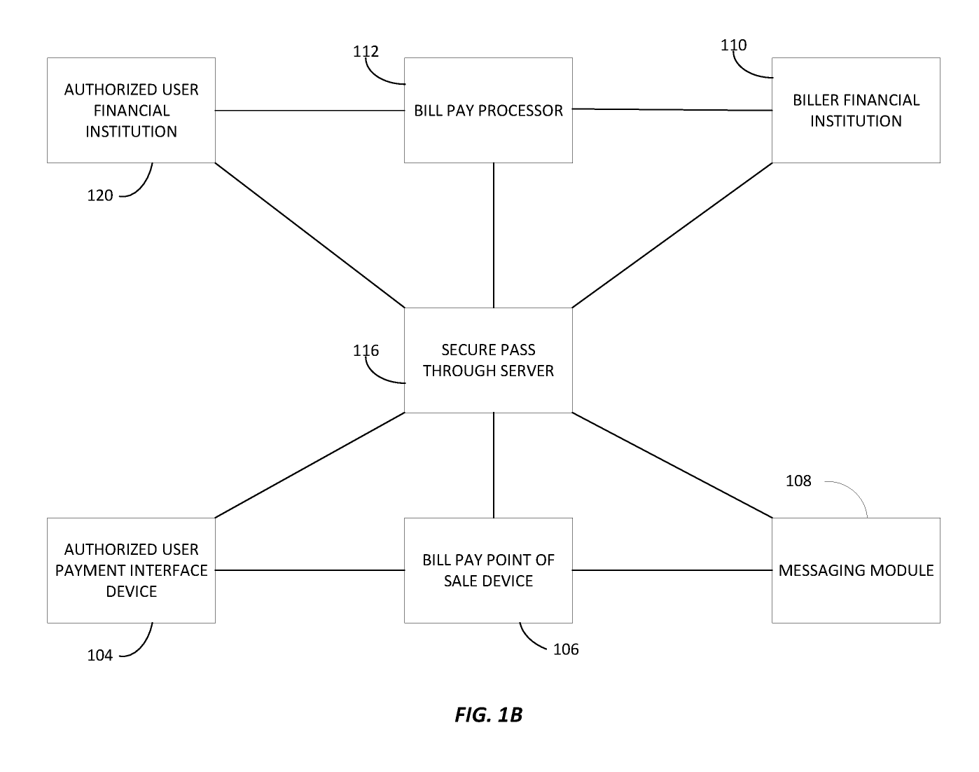

Embodiments of this application relate to systems and methods for a payer to electronically complete a payment to a biller without transmitting certain sensitive information, such as financial account data or personal data, to the biller. These embodiments achieve significant benefits over existing payment systems. As discussed above, existing payment systems are typically required to transmit sensitive information across computer networks. FIG. 1A is an example of one such payment process that suffers from this significant drawback. More particularly, FIG. 1A is a flowchart that generally depicts a current technique for processing payments between a purchaser and a seller using a credit card. The process begins at block 1051, where a customer presents a credit card to complete payment to a merchant in exchange for goods or services. The process then continues to block 1053, where the merchant transmits the customer's credit card information along with the details of the transaction to the acquiring bank associated with the customer's credit card. This data is transmitted typically using a credit card machine, software, or some other type of payment gateway and associated network or networks thereof. This transmitted data can include sensitive data such as the credit card number, expiration date, the customer name, and other similar types of information.

The process then continues at block 1055, where the acquiring bank (or its processor) captures the transaction information and routes it through the appropriate card network to the customer's issuing bank. Examples of card networks are the Banknet network provided by Mastercard, and the Visanet network provided by Visa. The issuing bank receives the transaction information at block 1057, and responds by approving or declining the transaction. In making this determination, the issuing bank may apply various criterion, including whether the transaction information is valid, the customer has sufficient balance to make the purchase, and/or that the account is in good standing. Based on this determination, the issuing bank sends a response code back through the card network to the acquiring bank (or its processor) and to the merchant as shown in block 1059. At block 1061, this response code is then sent to the merchant's credit card machine, software, or gateway where it is stored in a batch file awaiting settlement.

The systems and methods disclosed herein provide inventive solutions to the drawbacks associated with the process described in FIG. 1A. For example, in some embodiments, systems, such as the system 100 shown in FIG. 1B, and methods are provided wherein an authorized user/payer/purchaser (e.g., a customer) can make a payment transaction to a biller (e.g., brick and mortar stores, government entities, service providers, online stores, web based checkout, goods providers, or even a friend to whom payment is owed, etc.) via an electronic device (e.g., smartphone, mobile phone, tablet, computer, etc.) to complete a purchase (e.g., for goods and/or services). The electronic device may be referred to herein as an authorized user payment interface device and in some embodiments may correspond to the authorized user payment interface device 104 shown in FIG. 1B.

In some such embodiments, a functionality (e.g., an application, software, and/or some hardware component) may be provided on the authorized user payment interface device 104 that allows a user (e.g., via a user interface, via near field communication (NFC), via a secure communication channel, etc.) to securely access and receive biller data (e.g., biller identification information, billing information, total cost/funds required, item cost, and/or address, transaction identifier, etc.) associated with the payment transaction. For example, the authorized user payment interface device 104 may communicate via a secure communication channel (e.g., NFC, WiFi, Bluetooth, infrared, RFID, QR code, local communication channel, etc.) with a biller's computing device (e.g., server, desktop, tablet, POS system, etc.) to receive the biller data. The biller's computing device may be referred to herein as a biller point of sale device and in some embodiments may correspond to the biller point of sale device 106 shown in FIG. 1B.

The authorized user payment interface device 104 may further be configured to transmit the biller data to a computing device, such as a server, which receives the biller data such as via a secure wired and/or secure wireless connection. In some embodiments, the computing device may be a proxy server. The computing device may be a type of management server for managing payments, referred to herein as a secure pass-through server such as the secure pass-through server 116 shown in FIG. 1B. The secure pass-through server 116 may be integrated into or communicate with one or more financial institutions and may be securely accessed by authorized personnel only via financial computing devices (e.g., server, workstations, etc.) that are associated with or integral to the one or more financial institutions. The financial institutions may be financial institutions where the payer has one or more financial accounts and may be referred to herein as an authorized user financial institution and in some embodiments may correspond to the authorized financial institution 120. In some embodiments, the functionality described with respect to the secure pass-through server 116, the messaging module 108, and bill pay processor 112 may be hosted and/or otherwise controlled by the authorized user financial institution 120, and their respective functions may be performed by one device or server instead of separate devices or servers. This one device or server or separate devices or servers may be managed by and/or otherwise associated with or fully integrated into the technology infrastructure of the authorized user financial institution 120.

In some embodiments, the authorized user payment interface device 104 may be configured to modify (e.g., format) the biller data to comply with the requirements of a bill pay system (which may be referred to herein as a bill pay processor such as the bill pay processor 112 shown in FIG. 1B) of the financial institution before sending the biller data to the secure pass-through server 116. In some embodiments, the authorized user payment interface device 104 may transmit the biller data to the secure pass-through server 116 and the secure pass-through server 116 is configured to modify the biller data to comply with the requirements of the bill pay processor 112. In some embodiments, the functionality described with respect to the bill pay processor 112 and the authorized user financial institution 120 may be performed by one device or server instead of separate devices or servers. In addition, the functionality described with respect to the bill pay processor 112 may be provided by a financial institution (such as authorized user financial institution 120) as part of its service offering to customers.

Further, in some such embodiments, the secure pass-through server 116 may be configured to interface and communicate with the authorized user financial institution 120, such as via a secure wired and/or secure wireless connection to determine which financial accounts are associated with the user/payer based on identification information received from the authorized user payment interface device 104, and if there are sufficient funds in one or more of the associated payer financial accounts 202, 204a, 204b and 206 to complete the payment transaction.

In some such embodiments, the payer's financial accounts may include DDAs and other financial accounts not directly associated with, but linked to, the payer's POSDDA 206, at the authorized user financial institution 120, such as externally linked, bank-issued credit lines 204c and/or externally linked DDA's 205 or the like. Therefore, it should be noted that in certain embodiments, only the payer may draw down or direct sufficient funds from the internal or external traditional DDA's 202 and 205 or from the conjunctive credit line accounts 204a, 204b and 204c into the payer's POSDDA 206 to then complete a payment to a biller through the bill pay processor associated with the payer's POSDDA. Moreover, the payer's POSDDA funds cannot be drawn down or debited from any other source than the associated bill pay processor thereof. Thus, no debit or draw down of funds from the payer's POSDDA can occur except through a bill pay transaction. Furthermore, in certain embodiments, the conjunctive credit line accounts 204a, 204b and 204c associated with the payer's POSDDA cannot be debited by or from any other source than the authorized user/payer thereof, and such funds can only be drawn down into or directed into the payer's POSDDA.

Based on this information, the secure pass-through server 116 may send a request to the authorized user financial institution 120, associated with the payer chosen or determined financial accounts, requesting information regarding the availability of sufficient funds needed to complete the payment transaction. The request for available funds may be based on the biller data. The authorized user financial institution 120 may determine availability of sufficient funds by checking to see if the one or more of the internally hosted financial accounts or externally linked financial accounts (such as those discussed above associated with the payer) have enough funds to meet the amount of funds requested. In some embodiments, the authorized user financial institution 120 may then send an indication or message to the secure pass-through server 116 indicating whether the payer has sufficient funds to complete payment to the biller.

Based on the received indication or message, the secure pass-through server 116 may determine if sufficient funds are available in one or more accounts associated with the payer to complete the transaction. If there are not sufficient funds available, the secure pass-through server 116 sends an indication or message (e.g., SMS, MMS, e-mail, application specific message, etc.) to the authorized user payment interface device 104 and/or the biller point of sale device 106 that sufficient funds are not available and the payment transaction is not completed and may be declined.

If the secure pass-through server 116 determines there are sufficient funds available, the secure pass-through server 116 transmits the biller data and payer authorization needed to effectuate bill pay transfer of sufficient available funds (e.g., the amount specified in the biller data to complete the payment transaction) from the one or more accounts to the biller. For example, the secure pass-through server 116 may transmit appropriately formatted data to the authorized user financial institution 120 which allows it to initiate a bill payment (via bill pay processor 112) from one or more financial accounts by transmitting information required (e.g., all or a portion of the biller data) in the correct format to the bill pay processor 112, which, as noted previously, may be provided and/or managed by or fully integrated into the technology infrastructure of the financial institution 120. The bill pay processor 112 in turn makes a bill payment to the biller on behalf of the payer. The payment may be in the form of an electronic ACH credit to an account of the biller held at a biller financial institution 110 or as an internal direct payment made to an account of the biller held at the same financial institution of the authorized user 120 or the bill pay processor may generate the payment as a paper check item sent to the biller via some form of mail service and/or parcel package carrier. The payment may also be made via a shared ledger network having a public or private ledger system (e.g., block chain), or some other type of payment processing network.

After, concurrent, or just before the secure pass-through server 116 transmits the data which allows the authorized user financial institution 120 to initiate the bill payment, the secure pass-through server 116 may send a message including an indication (e.g., authorization code that is related to the payment transaction, transaction identifier, and/or payment made identifier, etc.) to the biller point of sale device 106 and/or the authorized user payment interface device 104 indicating that payment has been approved. If it has been approved, the biller can then release goods or services to the payer/user. For example, where the indication comprises the authorization code and/or a transaction I.D. and/or approval message, the biller point of sale device 106 may receive an authorization code and/or a transaction I.D. and/or approval message that matches the same authorization code and/or a transaction I.D. and/or approval message received by the authorized user payment interface device 104.

The secure pass through server 116 may then send a message to the biller point of sale device 106 that the transaction was approved or declined. In some embodiments, the message may be sent directly from the biller financial institution 110 to the biller point of sale device 106 and/or via the secure pass through server 116. Alternatively, the approval and decline messages may be sent from another source in the network.

It should be noted that in some cases, a bill payment may actually take one or more days to process before the biller receives the payment electronically or as a paper check item sent to the biller via some form of mail service and/or parcel package carrier.

Accordingly, in some embodiments, a guarantor, such as either a financial institution or third party that controls the secure pass-through server 116 may guarantee that payment will be made to the biller even if funds are not available during the one or more days the bill payment takes to process and be received by the biller.

In some embodiments, the system 100 further includes a messaging module 108. The messaging module 108 may be configured to send one or more context-relevant messages (e.g., advertisements related to the payment transaction, advertisements related to the user, coupons, rewards, etc.) to the authorized user payment interface device 104 for display on the device 104 at any time during or after the payment transaction. For example, the authorized user interface device 104 may receive, via the secure pass through server 116, such context-relevant messages originating at the messaging module 108. In some embodiments, the functionality described with respect to the messaging module 108 and the secure pass-through server 116 may be performed by one device or server instead of separate devices or servers.

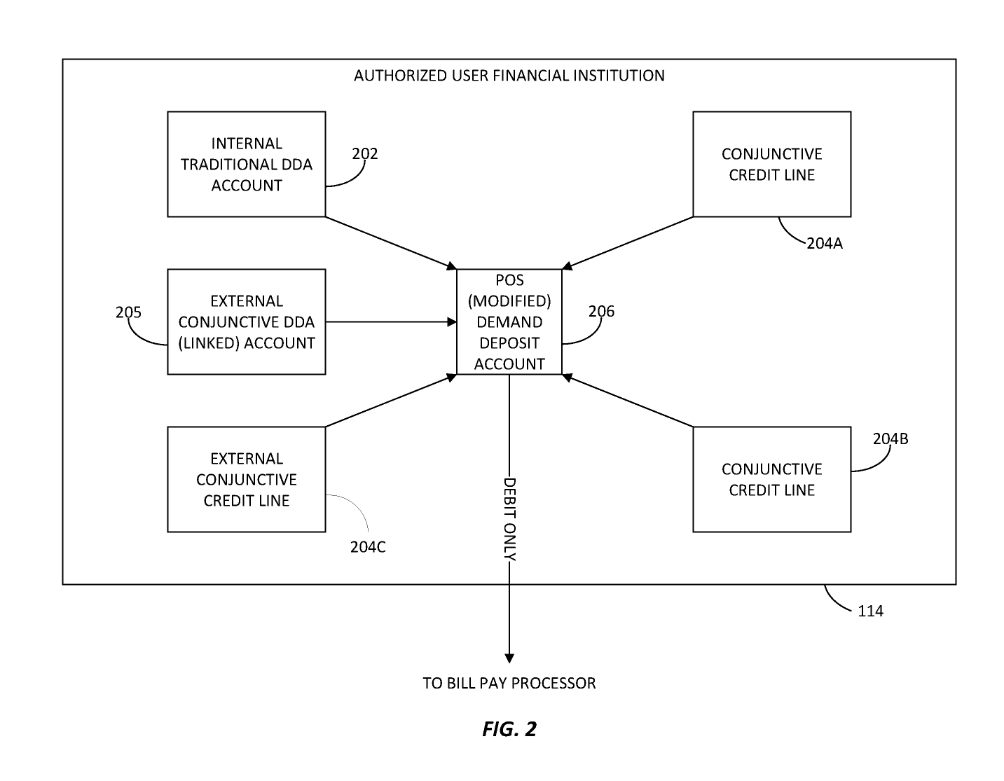

FIG. 2 illustrates an embodiment of the authorized user financial institution 120. As discussed above, the payer may have one or more accounts and/or one or more financial institutions associated with the payer that may all act as sources of funds available to complete the payment transaction. These one or more accounts may include one or more internally hosted or externally hosted linked conjunctive credit lines or internally or externally linked DDA's 204a, 204b, 204c, 202 and 205 (also referred to in the collective as conjunctive credit lines 204 and conjunctive linked DDA's 205). In some embodiments, there may be no conjunctive credit lines 204, one conjunctive credit line 204, or a plurality of conjunctive credit lines 204. Any of the conjunctive credit lines 204 may be provided by the financial institution associated with the authorized user financial institution 114 (e.g., conjunctive credit lines 204a and 204b), or may be provided by some other financial institution (e.g., external conjunctive credit lines 204c). If provided by another financial institution, the information (e.g., funds availability) about the external conjunctive credit line 204c may be shared with the authorized user financial institution 120, such as via a network. The conjunctive credit lines 204 may comprise a type of funding source for the user. The one or more accounts of the payer may further include a traditional demand deposit account (TDDA or traditional DDA), such as the traditional DDA account 202. The traditional DDA account 202, in some embodiments, may be a demand deposit account with the financial institution associated with the authorized user financial institution 114. The traditional DDA account 202 may comprise a type of funding source for the user.

The internally hosted traditional demand deposit account 202 and any externally hosted linked DDA's 205 may not always reflect the true state of funds availability. For example, check payments can take time to process, which may result in an account balance which appears higher than what can be relied upon at the time of a later debit demand. Accordingly, in some embodiments, the authorized user financial institution 120 includes a separate, modified demand deposit account which is generally referred to herein as a point of sale demand deposit account (POSDDA) 206.

This modified POSDDA 206 may be configured to receive funds directly debited from either the traditional demand deposit account 202 and/or any one or more of the internal or external conjunctive DDA's 205 or the internal or external credit lines 204 for an amount of funds specified by the payer. For example, the payer, upon receiving the bill from the biller point of sale device 106 indicating that a bill payment has been started, then may transmit a request via the pass through server 116 to debit either the traditional internal DDA 202 or externally linked demand deposit account 205 and/or the conjunctive credit lines 204 for an amount of funds equal to or greater than the amount of funds needed to complete the payment transaction and direct the funds into the POSDDA 206. The funds may then be paid out of the POSDDA 206 to the biller via the bill pay processor 112. The payer 104 therefore has assurances that sufficient funds are always available to make the payment to the biller. Additionally or alternatively, the payer may keep a certain amount of funds dedicated in the POSDDA 206 for bill payments and only authorize bill payments up to the amount available in the POSDDA 206. Accordingly, any transfers of funds made by the payer to the bill pay processor 112 for delivery to the biller financial institution 110 may be made from funds available in the POSDDA 206.

The POSDDA may be structured such that it is only permitted to be utilized for certain credit transactions. In some embodiments, the POSDDA may be limited to those transactions in which funds are first received as credits into the POSDDA account, of which are then transmitted to the biller as a credit via the bill pay processor 112. In various embodiments, the POSDDA 206 may be based on credits and not debits in order to preserve its limited functionality as may be defined by specific rules which govern how money may flow into and out of the POSDDA account. These rules may require that the only way that money can leave the account is via an ACH transaction through the bill pay processor (or some other similar type of payment processing technology). Thus, the POSDDA 206 may only be permitted to be debited from a single source. By limiting the ability for the POSDDA to be debited only via ACH (or some other similar type of payment processing technology) by the bill pay processor, the POSDDA provides security and a guarantee of funds that is not currently possible in point-of-sale environments. The configuration of the POSDDA and the rules governing how money can be debited from that account create a type of settlement intelligence that prevents payments from being returned for insufficient funds. By enabling the system to recognize if and when funds are already dedicated to make payments, and modifying the POSDDA ledger accordingly, a good funds model is created in which there is virtually no risk that a payment is not ultimately honored. The nature of the POSDDA 206 significantly improves upon current drawbacks of the existing bill pay system, as the existing bill pay systems do not have an adequate or full-proof way to ensure funds availability.

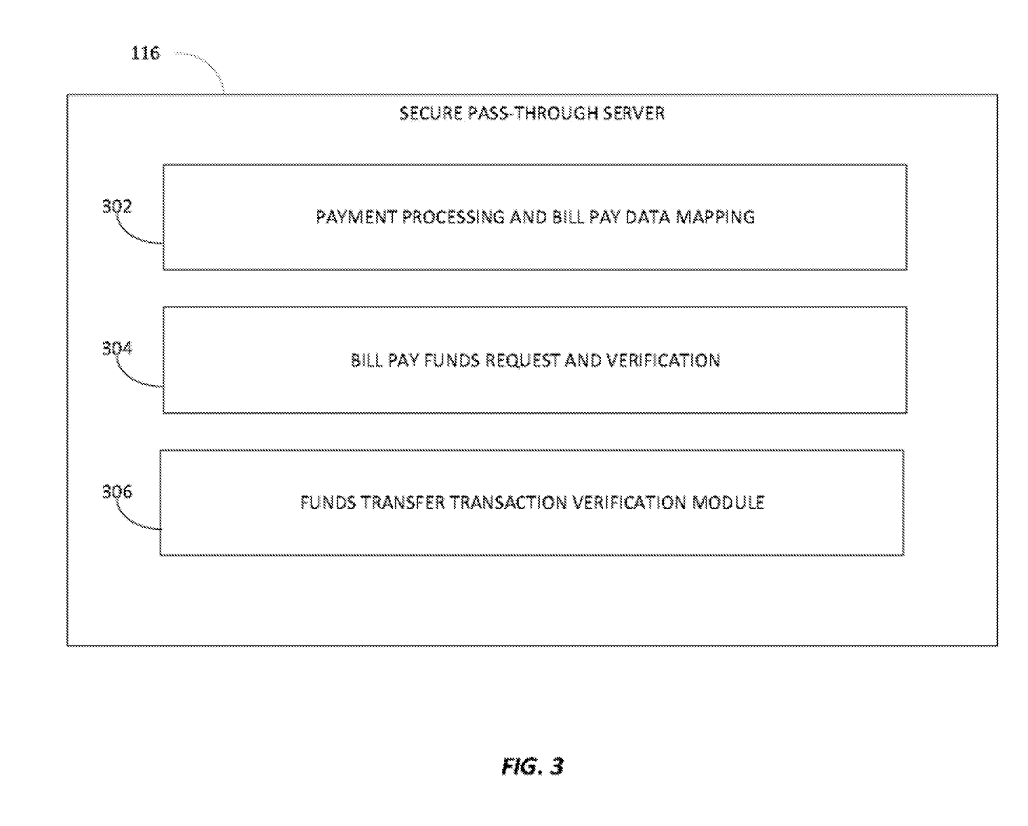

FIG. 3 illustrates an embodiment of the secure pass-through server 116. As shown, the secure pass-through server 116 may include a payment processing and bill pay data mapping module 302. The payment processing and bill pay data mapping module 302 may be configured to modify (e.g., format) the biller data received from the authorized user payment interface device 104 to comply with the requirements of the bill pay processor 112 as discussed above. The payment processing and bill pay data mapping module 302 may further be configured to send the modified biller data to the bill pay processor 112 to initiate/facilitate a transfer of funds as discussed above.

The secure pass-through server 116 may further include a bill pay funds request and verification module 304. The bill pay funds request and verification module 304 may be configured to interface with the authorized user financial institution 120 to request and/or verify that an amount of funds needed for the payment transaction is available from one or more internally hosted or externally hosted accounts associated with the user. The accounts associated with the user may include the internally hosted TDDA account 202 or externally linked DDA's 205 and internally hosted conjunctive credit lines 204, including externally hosted conjunctive credit lines 204c. Further, the bill pay funds request and verification module 304 may be configured to receive an indication of whether the amount of funds is available from the authorized user financial institution 120.

The secure pass-through server 116 may further include a funds transfer transaction verification module 306 that is configured to verify that a bill payment for the amount of funds has been initiated by the bill pay processor 112, such as by receiving an indication of the initiation of the bill payment from the bill pay processor 112 as discussed above. The funds transfer transaction verification module 306 may further be configured to send an indication to the authorized user payment interface device 104 and/or the biller point of sale device 106 of whether or not the bill payment has been initiated as discussed above. The funds transfer transaction verification module 306 may further be configured to send an indication to the authorized user payment interface device 104 and/or the biller point of sale device 106 of whether or not the bill payment was successfully completed and funds transferred to the biller financial institution 110 as discussed above.

Although described separately, it is to be appreciated that functional blocks/modules described with respect to the secure pass-through server 116 need not be separate structural elements. For example, the modules 302, 304, and 306 may be embodied in a single chip.

The modules 302, 304, and 306 may be implemented as software, firmware, hardware, or any combination thereof. For example, the modules 302, 304, and 306 can be a general purpose processor, a digital signal processor (DSP), an application specific integrated circuit (ASIC), a field programmable gate array (FPGA) or other programmable logic device, discrete gate or transistor logic, discrete hardware components, memory, software or any suitable combination thereof designed to perform the functions described herein. A processor may also be implemented as a combination of computing devices, e.g., a combination of a DSP and a microprocessor, a plurality of microprocessors, one or more microprocessors in conjunction with a DSP core, or any other such configuration.

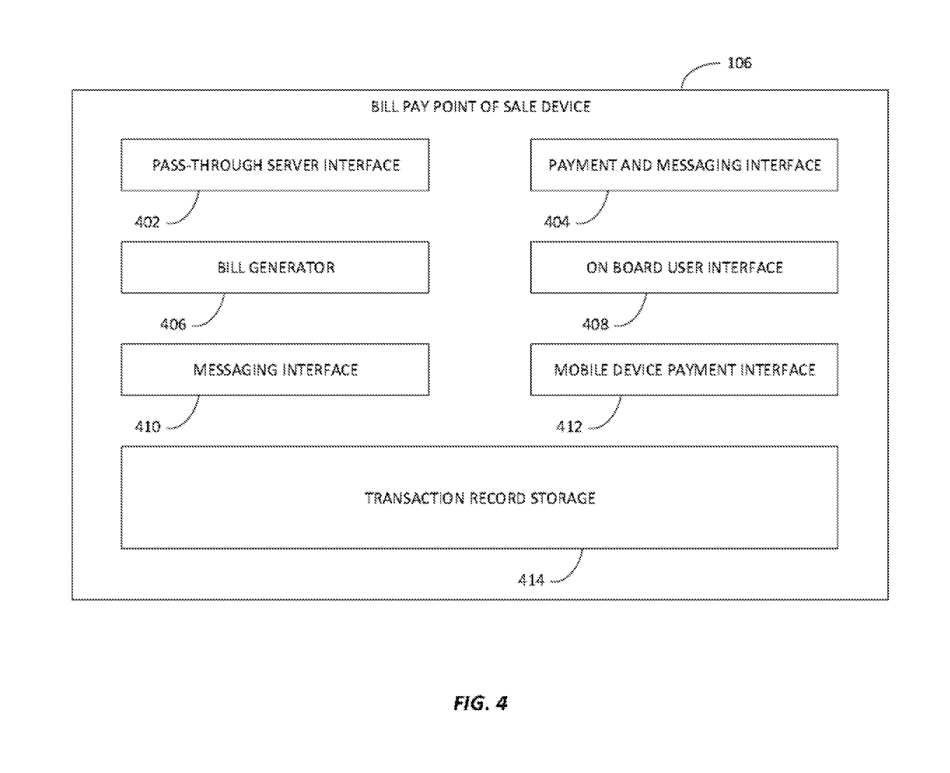

FIG. 4 illustrates an embodiment of the biller point of sale device 106. As shown, the biller point of sale device 106 may include a pass through server interface 402. The pass through server interface 402 may be configured to interface with the secure pass-through server 116 as discussed above. For example, the pass through server interface 402 may comprise a driver, software, and/or hardware (e.g., network interface) that configures and exchanges data with the secure pass-through server 116. The pass through server interface 402 may be configured to send and receive data (e.g., messages, indications, etc.) related to processing of bill payments.

The biller point of sale device 106 may further include a mobile device payment interface 412. The mobile device payment interface 412 may comprise one or more of the following types of interfaces: NFC, WiFi, Bluetooth, infrared, RFID, QR code, etc. The mobile device payment interface 412 may be configured to interface with the authorized user payment interface device 104 as discussed above. For example, the mobile device payment interface 412 may be configured to exchange biller data for a payment transaction with the authorized user payment interface device 104 as discussed above. The mobile device payment interface 412 may comprise a driver, software, and/or hardware (e.g., network interface). It is to be appreciated that the systems and methods described herein could also be used in a traditional online purchase transaction.

Thus, in some embodiments, the biller point of sale device may be a web site which allows a customer to purchase items and pay for them online. In this context, when a user reaches a payment screen, a QR code or some other type of message may be presented to the user. This QR code (or other type of message) may include all of the pertinent transaction information. The QR code may be scanned or otherwise received by the user into their mobile device using the mobile device payment interface 412, and transmitted via the pass through server interface 402 to the secure pass-through server 116 as described above. It is to be further appreciated that the biller may use a television advertising medium to effectuate purchase transactions as well. In these embodiments, an advertised product or service may be displayed on a television screen. A QR code or some other associated identifier containing the bill may be displayed on the television screen with the product or service. If a purchaser wants to purchase the advertised product or service, the purchaser may scan the QR code or some other associated identifier using the authorized user payment interface device 104 to capture the bill into the app (and then the system goes through the same routine as POS brick and mortar would to fulfill the sale, except, instead of having a human on the other side of the counter, a virtual biller POS server may be configured to receive authorization of good or bad funds, transaction I.D. and completed payment to then release product(s) or services for shipping).

In another embodiment, a phone or text number or some other communication interface solution can be displayed on the television screen with the product or service. If a purchaser wants to purchase the advertised product or service, the purchaser can physically key the phone or text numbers into the authorized user payment interface device (phone) or scan some other communication interface solution into the phone from the TV screen in order to transmit a message to the biller point of sale device 106 identifying the product or service items to be purchased. The biller virtual point of sale device 106 may then respond to the message with an itemized invoice back into the mobile device payment interface 412 which provides information about the purchase transaction. The customer may then pay for the item using the POSDDA as described in detail below. In yet other embodiments, the purchase transaction may be a bricks and mortar point of sale transaction which avoids the need for a check out process. In these embodiments, a bricks and mortar establishment may provide a code (such as a barcode, QR code, etc.) on items available for purchase. When a shopper wants to purchase an item, the shopper may scan the code on the item. In response to scanning the code on the item, the biller point of sale device 106 may automatically initiate a purchase transaction through the mobile device payment interface, in some cases immediately or in other cases, after all scanned items are compiled into one bill 412. By automatically initiating the payment, the need for the consumer to bring the item through a checkout process is avoided.

The biller point of sale device 106 may further include an on board user interface 408. The user interface 408 may comprise software, hardware, firmware, or a combination thereof to display an interface (e.g., graphical user interface) to a biller or other user of the biller point of sale device 106. The user interface 408 may include, for example, a display and an input device, such as a display with a touch screen. The user interface 408 may further include a graphical user interface that is displayed on the display that allows a user of the biller point of sale device 106 to control it according to the functions described herein. For example, the user interface 408 may display information regarding the transaction including line items, costs, approval of transactions, availability of funds, context-relevant messages, and other information described herein.

The biller point of sale device 106 may further include a bill generator 406. The bill generator 406 may comprise software, hardware, firmware, or a combination thereof to generate the biller data that is transferred to the authorized user payment interface device 104. The biller point of sale device 106 may also include a payment and messaging interface 404. The payment and messaging interface 404 may be configured to process messages received from the secure pass-through server 116, the authorized user payment interface device 104, and/or the messaging module 108. For example, the payment and messaging interface 404 may be configured to receive messages or data from the messaging interface 410 and process the messages for display on the biller point of sale device 106 using the on board user interface 408. Further, the payment and messaging interface 404 may be configured to send and/or receive messages or data from the mobile device payment interface 402 and process the messages, such as to receive biller data from the bill generator 406 and process it for transmission to the authorized user payment interface device 104 via the mobile device payment interface 412. The payment and messaging interface 404 may also process authorization codes received from the pass through server interface 402 and/or the mobile device payment interface 412 from the secure pass-through server 116 and the authorized user payment interface device 104, respectively.

The payment and messaging interface 404 may be configured to receive messages or data from the pass through server interface 402 and process the messages, such as to verify availability of funds of the user for completing the payment transaction, whether a bill payment has been initiated, whether funds have been received in the biller financial institution 110, and other functions described herein.

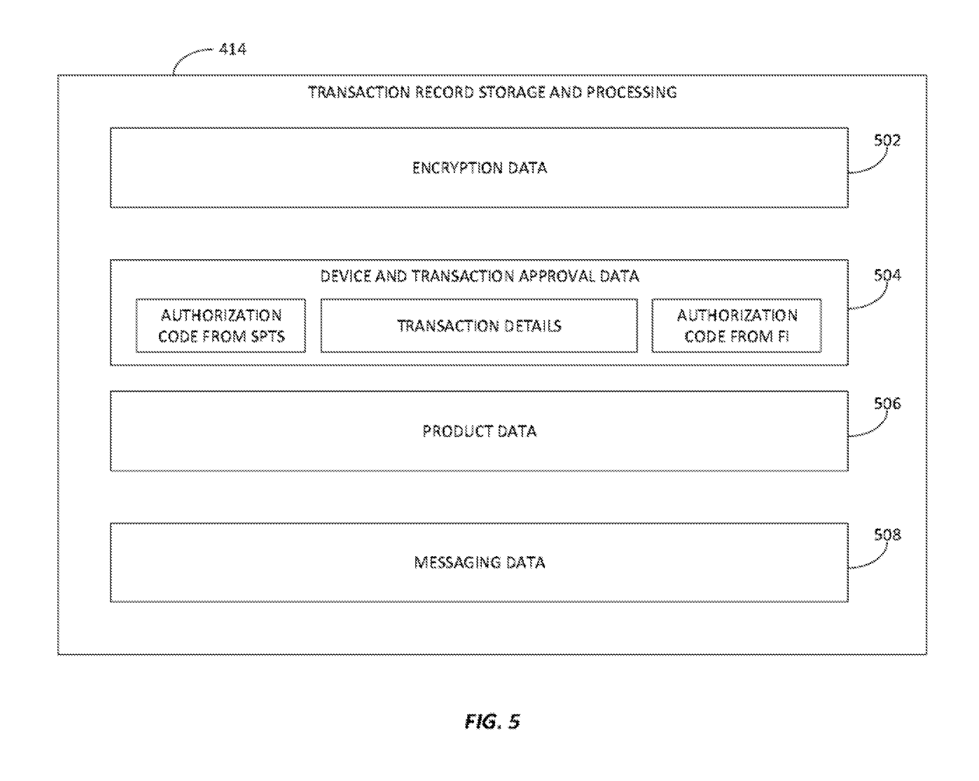

The payment and messaging interface 404 may be coupled to the transaction record storage 414, which may comprise physical memory and/or a data storage structure. Although it is shown as being incorporated into the biller point of sale device 105, a skilled artisan will readily appreciate that the transaction record storage 414 may be physically separate from the biller point of sale device. As shown in FIG. 5, the transaction record storage 414 may include an encryption data portion 502, a device and transaction approval data portion 504, a product data portion 506, and/or a messaging data portion 508. The payment and messaging interface 404 may store and retrieve data related to processing of messages and other information from the transaction record storage 414. The encryption data portion 502 may include data related to encryption protocols, security keys, etc. for generating or processing encrypted messages. The device and transaction approval data portion 504 may include data related to payment transactions, such as authorization codes from the authorized financial institution 120, the secure pass-through server 116, and/or authorized user payment interface device 104 associated with the payment transaction and/or other transaction details, such as biller data.

The product data portion 506 may include a database or list of products and/or services available for purchase from the biller, including information about the products and/or services, such as details, descriptions, costs, etc. The messaging data portion 508 may include data to be used for generation of context-relevant messages, such as information regarding which products are related to products being purchased, etc.

Although described separately, it is to be appreciated that functional blocks/modules described with respect to the biller point of sale device 106 need not be separate structural elements.

The modules 402, 404, 406, 408, 410, 412, and 414 may be implemented as software, firmware, hardware, or any combination thereof. For example, the modules 402, 404, 406, 408, 410, 412, and 414 can be a general purpose processor, a digital signal processor (DSP), an application specific integrated circuit (ASIC), a field programmable gate array (FPGA) or other programmable logic device, discrete gate or transistor logic, discrete hardware components, memory, software, or any suitable combination thereof designed to perform the functions described herein. A processor may also be implemented as a combination of computing devices, e.g., a combination of a DSP and a microprocessor, a plurality of microprocessors, one or more microprocessors in conjunction with a DSP core, or any other such configuration.

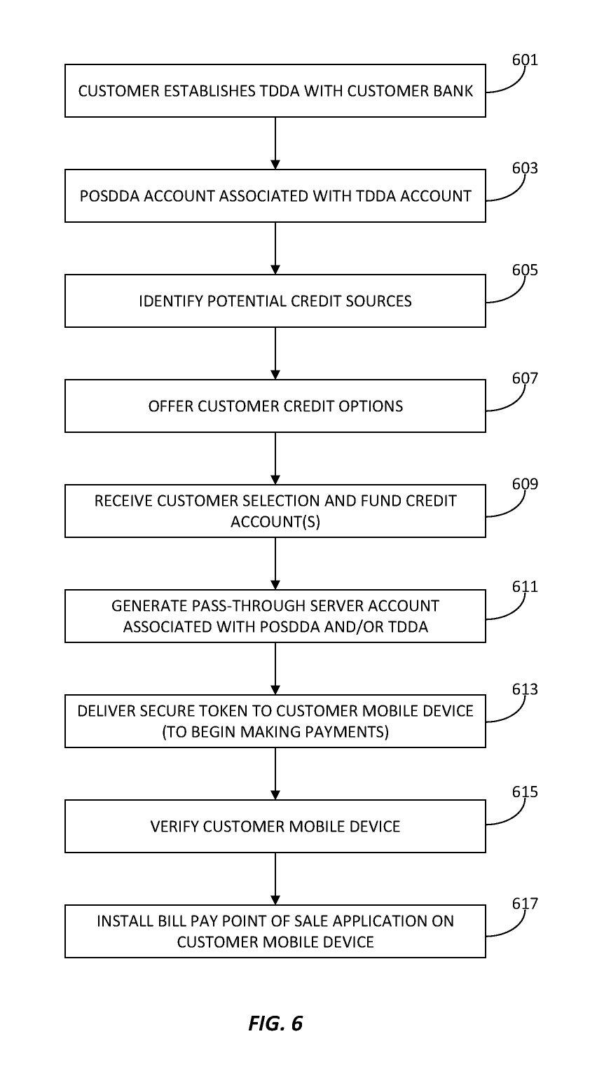

FIG. 6 illustrates an example of a process for establishing accounts and verifications for making secure payments using the system 100. At block 601, a user (e.g., customer) establishes a TDDA (traditional demand deposit account) with bill pay capability with the financial institution (e.g., bank), such as authorized user financial institution 120. For example, the user may utilize the authorized user payment interface device 104 to exchange data with the authorized user financial institution 120 to setup a TDDA with bill pay capability. Further, at block 603, a POSDDA 206 is created.

Continuing, at block 605, potential funding sources are identified (e.g., TDDA and/or conjunctive credit lines) to work in conjunction with the POSDDA to conduct bill pay transactions. For example, the payer may utilize the authorized user payment interface device 104 to input information regarding potential credit sources and exchange the information with the authorized user financial institution 120 to allow the authorized user financial institution 120 to access the potential credit sources. Additionally or alternatively, the authorized user financial institution 120 may utilize information (e.g., social security number, account number, etc.) about the payer to automatically identify potential credit sources already linked to the payer.

Further, at block 607, the authorized user financial institution 120 may generate and send credit options (e.g., lines of credit, debit accounts, etc.) to the user, such as via the authorized user payment interface device 104. Continuing at block 609, the authorized user financial institution 120 may receive from the user, such as via the authorized user payment interface device 104, selection of one or more credit sources, such as the potential credit sources and/or credit options. The authorized user financial institution 120 may utilize the information about the selected one or more credit sources to fund the POSDDA 206 with funds from the selected one or more credit sources.

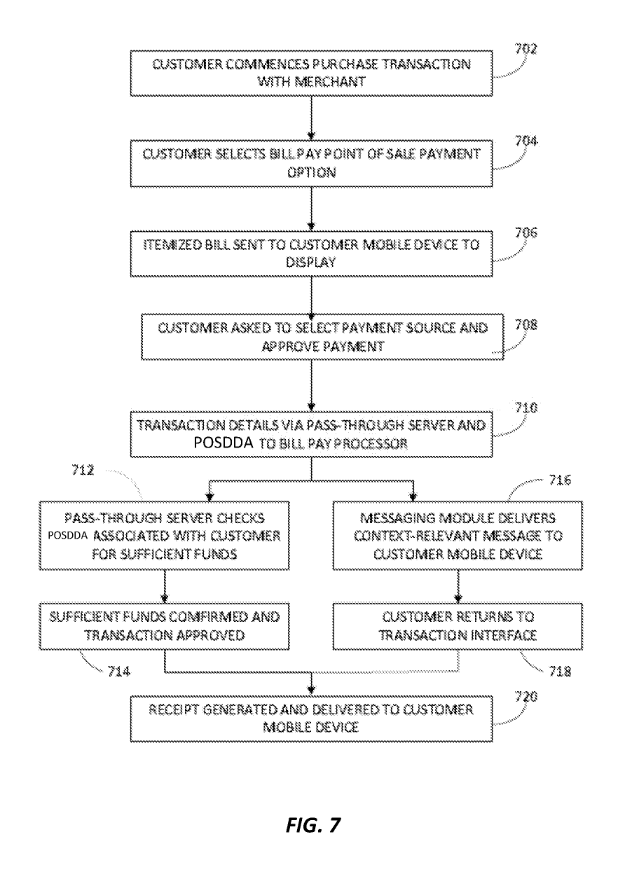

Continuing, at block 611, the authorized user financial institution 120 and/or secure pass-through server 116 may, through the secure pass-through server 116, establish an account associated with the POSDDA. For example, the authorized user financial institution 120 may transmit information to the secure pass-through server 116 associating the payer with the POSDDA 206. As will be discussed in more detail below in connection with FIG. 7, the secure pass-through server 116 may store this information and utilize it to facilitate payment transactions on behalf of the authorized user, whereby payment to the biller is effectuated as a POSDDA bill pay transaction.

Further, at block 613, the secure pass-through server 116 may generate a security token (e.g., token, certificate, shared key, etc.) associated with the bill pay account and send the security token to the authorized user payment interface device 104. The secure pass-through server 116 and authorized user payment interface device 104 may utilize the security token to verify, secure, and/or encrypt data exchanged between the devices and ensure that the devices are valid and the system has not been compromised by a third party.

At block 615, the payer may transmit verification information (e.g., social security number, security token, etc.) to the secure pass-through server 116 using the authorized user payment interface device 104 to verify that the authorized user payment interface device 104 belongs to the user. At block 617, the secure pass-through server 116 may directly or indirectly install a bill pay point of sale payment application on the authorized user payment interface device 104 to allow the payer to make secure payments as discussed herein.

FIG. 7 illustrates an example of a process for completing a payment transaction using the system 100. At block 702, a user (e.g., customer) begins a payment transaction (e.g., a purchase transaction for goods or services) with a biller (e.g., merchant) by selecting an item for purchase. As noted above, the payment transaction may be any one of various types of payment transactions, including an internet sales transaction, a bricks and mortar point of sale transaction (with or without a checkout procedure), a purchase selected from a television advertisement, or a person-to-person transaction. At block 704, the payer may select an option to use a bill pay point of sale payment application for completing the purchase. Further, at block 706, the payer may receive from the biller point of sale device 106 an itemized list of items and costs (e.g., an invoice or bill of items) and it may be displayed through the bill pay point of sale payment application residing on or within the authorized user payment interface device 104.

Continuing, at block 708, the payer is prompted to select a payment source and then approve the payment transaction. The selection of the payment source may be made using the bill pay point of sale payment application on the authorized user payment interface device 104. The payment source may be any one or more of the traditional DDA 202, external DDA 205, the conjunctive credit line(s) 204, or any other identified funding account source. In some embodiments, the payer may be presented a menu on their interface device 104 which shows their various available payment sources. The displayed available payment sources may include each of their accounts at the authorized user financial institution 120. Alternatively, only payment sources with sufficient funds for the payment transaction may be displayed for selection. In some additional implementations, the payer may be permitted to shift money between their various payment sources, or even to select multiple payment sources for the payment.

Further, at block 710, if the payer approves the payment transaction, the authorized user payment interface device 104 transmits biller data associated with the payment transaction to the secure pass-through server 116. Continuing, at block 712, the secure pass-through server 116 checks with the authorized user financial institution 120, including for example, the POSDDA account and other payment sources, to determine whether the selected payment source(s) has sufficient funds to complete the payment transaction. Further, at block 714, the secure pass-through server 116 confirms that sufficient funds are available based on information received from the authorized user financial institution 120.

At or near the same time that the payer and/or the secure pass-through server 116 checks and confirms available funds, the messaging module 108, at block 716, may deliver context-relevant messages to the authorized user payment interface device 104 for display to the user. These context-relevant messages may include advertisements such as a banner ad, a video, an audio message, a graphic message, an animation, or even a text message displayed in the bill pay point of sale payment application. Further, after the context-relevant message is displayed to the user, the authorized user payment interface device 104 may, at block 718, return to displaying an interface related to completing the payment transaction. It should be appreciated that the context-relevant messages may be provided at any time during or after the payment transaction process shown in FIG. 7. At block 720, after the bill payment is initiated, a receipt for the payment may be generated by the secure pass-through server 116 and sent to the authorized user payment interface device 104 for display. Alternatively, the receipt may be generated by the biller point of sale device and transmitted to the authorized user payment interface device 104.

FIG. 8 illustrates an example of a process for approving a payment transaction using the system 100. A user (e.g., customer) may begin a payment transaction (e.g., purchase transactions for goods or services) with a biller (e.g., merchant) by selecting an item for purchase. The biller passes the biller data (e.g., the bill or invoice) to the authorized user payment device 104. At block 801, the secure pass through server 116 receives a transaction payment request, which includes the biller data, directly from the authorized user payment interface device 104. Alternatively, the secure pass through server 116 may receive biller data directly from the biller point of sale device 106. In either case, the biller data may include a transaction payment request and an authorization code and/or security token associated with a user and/or authorized user payment interface device 104.

Continuing, at block 803, the secure pass through server 116, based on the received security token, identifies a bill pay account associated with the user. Further, at block 805, the payer checks with the authorized user financial institution 120 to see if one or more accounts (e.g., the POSDDA) associated with the payer have sufficient funds to complete the payment transaction. This checking of the accounts may be implemented by sending a message to the authorized user financial institution 120. If at block 807, it is determined there are not sufficient funds in the one or more accounts currently associated with the user, the process continues to block 809. At block 809, the secure pass through server 116 checks with the authorized user financial institution 120 to see if any backup funding source is available with funds for the payment transaction, such as an external conjunctive credit line. If at a block 809, it is determined there are not sufficient funds in a backup funding source or no back up funding source is identified to complete the payment transaction, the process continues to a block 811. At the block 811, the secure pass through server 116 checks with the authorized user financial institution 120 to see if any credit options can be offered to the user, such as a line of credit from the financial institution associated with the authorized user financial institution 120 to provide funds for the payment transaction. If at the block 811, it is determined no credit options can be offered to the user, or the user declines the credit options, the process continues to a block 813 where the payment transaction is declined.

If at any of blocks 807, 809, or 811, it is determined there are funds available to complete the payment transaction, the process continues to the block 815. At the block 815, the secure pass through server 116 approves the payment transaction. Further, at block 817, the secure pass through server 116 initiates a transfer of funds through bill pay. Here, the secure pass through server 116 may send a message to the authorized user financial institution 120 requesting that payment be made. The authorized user financial institution 120 through the POSDDA bill pay interface, effectuates payment to the biller's financial institution 110.

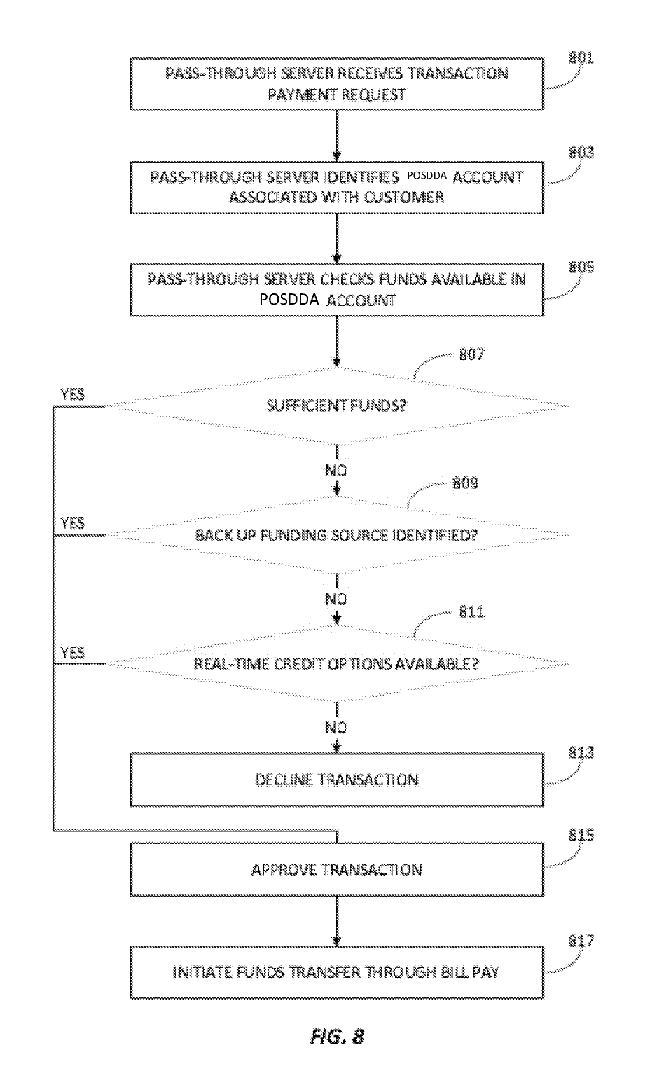

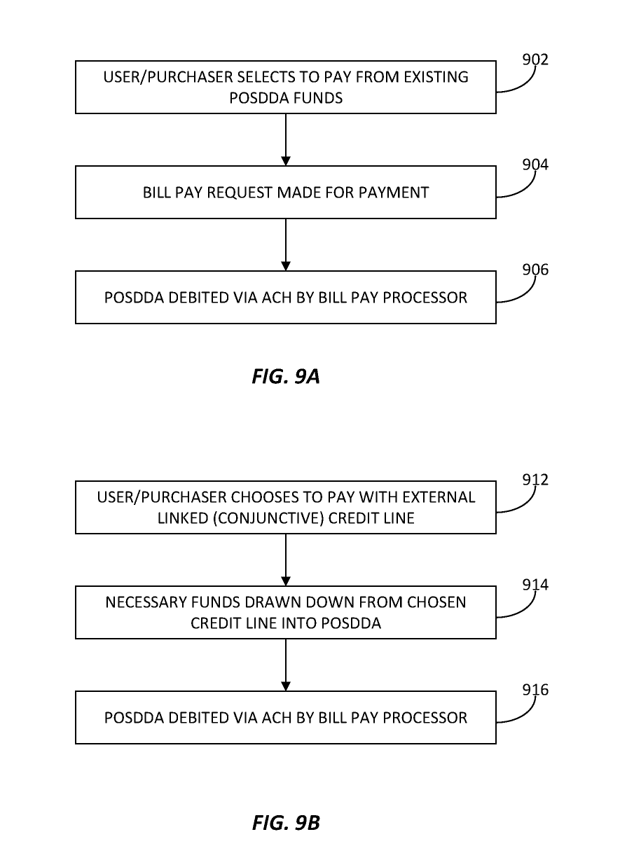

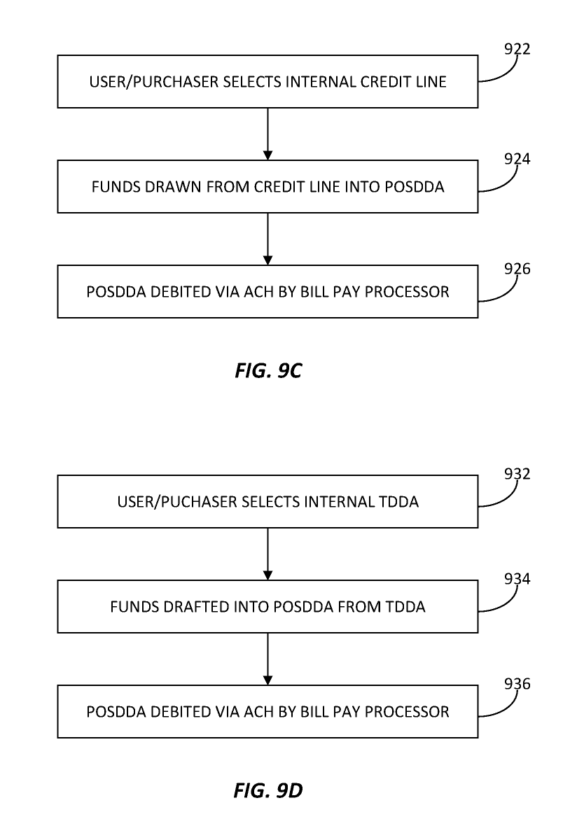

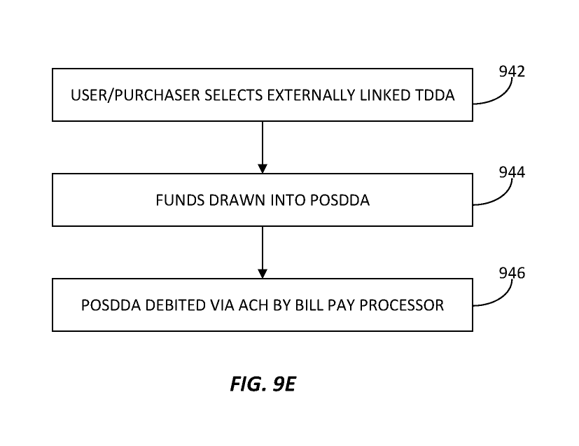

FIGS. 9A-9E are flow diagrams that provide various examples of how the POSDDA 206 may be funded, and how good funds may be ensured to the merchant/recipient of the payment. As briefly discussed above, there are various ways that funds may be made available to the POSDDA for payment. Various different funding scenarios are shown in FIGS. 9A-9E. Turning first to FIG. 9A, the process is shown by which a payment is funded via existing POSDDA funds. The process begins at block 902. There, the user/purchaser in the context of a purchase transaction, selects to pay from existing POSDDA funds. As discussed above, this option may be made available when there are sufficient funds in the POSDDA account to complete the payment transaction. Is further noted above, because the POSDDA make not be debited from any source other than the ACH (or some other similar type of payment processing technology) by the bill pay processor, the merchant/seller is virtually guaranteed that payment will be made and successfully received. Once the selection has been made to pay from existing POSDDA funds, the process moves to block 904. There, a bill pay request is made for payment to cover the transaction. Because the request is made on the POSDDA via ACH by the bill pay processor, this request may be granted as it complies with the rules governing the crediting and debiting of the POSDDA. Once the request is made for payment, the process then moves to block 906. There, the POSDDA is debited for the transaction amount via an ACH (or some other similar type of payment processing technology) transaction initiated by the bill pay processor 112.

Turning now to FIG. 9B, a flow diagram illustrates a scenario in which a user chooses to pay a bill using externally linked credit lines such as one of the external, linked conjunctive credit line 204C discussed in connection in FIG. 2 above. In this instance, the external linked credit line is presented among the menu of options presented to the customer/user via the AUPID 104. Thus, at block 912, the user/purchaser chooses to pay with the external, linked conjunctive credit line 204C. Once the user/purchaser has made the selection, the process moves to block 914. There, the necessary funds are drawn down from the selected credit line and into the POSDDA. Depending on the specific implementation, the externally linked credit line funds may be automatically drawn into the POSDDA using some sort of shared ledger network, such as a block chain or similar network, or through some other related or unrelated network that supports release of funds via the user selected credit line. In some embodiments, the selected conjunctive credit line 204C may be configured such that they cannot be debited by any other source than a user command, and credit line funds may only be drafted into the user POSDDA. Once the funds have reached the POSDDA, the process moves to block 916. There the POSDDA is debited via an ACH transaction by the bill pay processor 112. As with the other debit transactions associated with the POSDDA, this transaction is permitted because it is a debit transaction initiated via ACH (or some other similar type of payment processing technology) by a bill pay processor 112.

FIG. 9C provides an illustration of the process that takes place when the user/purchaser selects an internal conjunctive credit line or payment, such as conjunctive credit line 204A or 204B illustrated above in connection with FIG. 2. In this payment scenario, the user may select an internally coast credit line using the AUPID from among various options presented based on available funding as determined by the secure pass through server 116. The process begins at block 922, where the user/purchaser selects the internal conjunctive credit line from among the options presented. Is to be appreciated, that if the internally hosted credit line is overextended, it will not be presented as an available option in the AUPID. Is to be further appreciated, as discussed above, that the credit line is a dedicated credit line cannot be debited from any other source besides the user command in connection with funding the POSDDA, and that those funds may only be drafted into the user POSDDA. The process continues at block 924, where funds are drawn from the conjunctive credit line into the POSDDA. In some implementations, the POSDDA host bank may draft the funds from the credit line as an automatic function within the bank itself as an “on us” debit transaction. Additionally, a modified overdraft could be utilized in connection with the internal credit line, and the POSDDA may be funded using funds made available through a modified overdraft tool. Once the funds are drawn from the credit line into the POSDDA, the process moves then to block 926. There, the POSDDA is debited via an ACH transaction (or some other similar type of payment processing technology) initiated by the bill pay processor 112.

In some payment situations, the user/purchaser may wish for funds to simply be drawn out of a traditional demand deposit account held at the same financial institution as their POSDDA. FIG. 9D provides an illustration of this process. The process begins here at block 932, where the user/purchaser selects their internal traditional demand deposit account as the source for payment in a payment transaction. The process then moves to block 934, where the funds are drafted into the POSDDA from the traditional demand deposit account. Because the funds are immediately drawn into the POSDDA, there is no risk to the merchant that the payment will not be honored. The movement of the funds from the TDDA into the POSDDA may be an automatic function performed within the host bank as an “on us” debit transaction. Alternatively, it may be performed with a modified overdraft tool that ensures funds availability in the TDDA for other TDDA transactions that may take place subsequent to the instant payment transaction. Other methods may also be used. Once the funds have been moved into the POSDDA, the process moves to block 936. There the POSDDA is debited via ACH (or some other similar type of payment processing technology) by the bill pay processor.

Turning now to FIG. 9E, an example of a payment scenario utilizing an externally linked traditional demand deposit account is provided. In this scenario, the user/purchaser has selected an externally linked demand deposit account as a source of funding. The process begins at block 942 where the user/purchaser selects the externally linked TDDA. The process then moves to block 944 were funds are drawn from the externally linked TDDA into the POSDDA. The externally linked TDDA funds may be automatically drawn down into the POSDDA through the ACH network, through a type of shared ledger network like a block chain or similar network, or through some other related or unrelated network that supports the release of funds from the user chosen external TDA into the user POSDDA. Once the funds have been drawn into the POSDDA, process then moves to block 946. There, the POSDDA may be debited via an ACH transaction (or some other similar type of payment processing technology) by the bill pay processor.

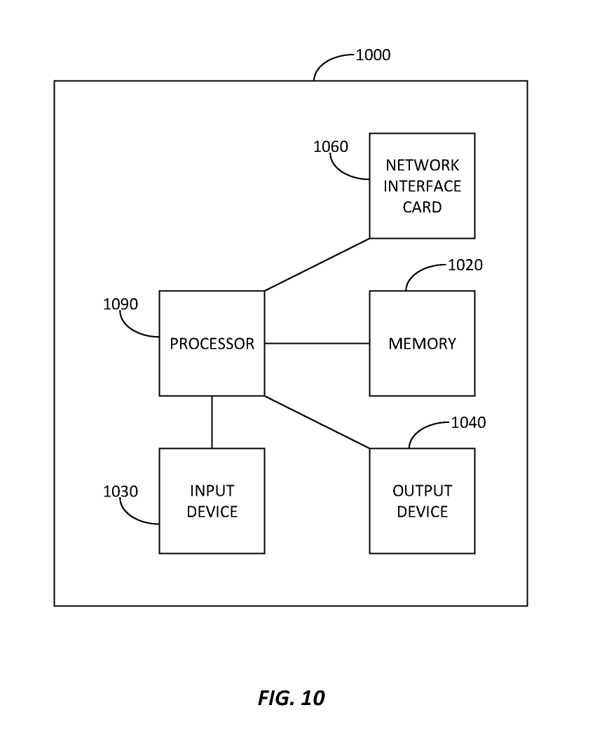

FIG. 10 illustrates a functional block diagram of one example of a computing device 900, such as any of the authorized user financial institution 120, the bill pay processor 112, the biller financial institution 110, the secure pass through server 116, the authorized user payment interface device 104, and/or the biller point of sale device 106, according to the embodiments described herein. The computing device 1000 includes a processor 1090 in data communication with a memory 1020, an input device 1030, and an output device 1040. The processor is further in data communication with a network interface device 1060. In some embodiments, the network interface device 1060 comprises a transceiver configured for wireless communication. In other embodiments, the network interface device 1060 comprises a wired network interface. Although described separately, it is to be appreciated that functional blocks described with respect to the computing device 1000 need not be separate structural elements. For example, the processor 1090 and memory 1020 may be embodied in a single chip.

The processor 1090 can be a general purpose processor, a digital signal processor (DSP), an application specific integrated circuit (ASIC), a field programmable gate array (FPGA) or other programmable logic device, discrete gate or transistor logic, discrete hardware components, or any suitable combination thereof designed to perform the functions described herein. A processor may also be implemented as a combination of computing devices, e.g., a combination of a DSP and a microprocessor, a plurality of microprocessors, one or more microprocessors in conjunction with a DSP core, or any other such configuration.

The processor 1090 can be coupled, via one or more buses, to read information from or write information to memory 1020. The processor may additionally, or in the alternative, contain memory, such as processor registers. The memory 1020 can include processor cache, including a multi-level hierarchical cache in which different levels have different capacities and access speeds. The memory 1020 can also include random access memory (RAM), other volatile storage devices, or non-volatile storage devices. The storage can include built-in or removable flash memory, or other appropriate storage mediums.

The processor 1090 also may be coupled to an input device 1030 and an output device 1040 for, respectively, receiving input from and providing output to a user of the computing device 1000. Suitable input devices include, but are not limited to, a keyboard, buttons, keys, switches, a digitizer for stylus input, a touch screen (e.g., capacitive or resistive), an infrared detector, a camera (possibly coupled with video processing software to, e.g., detect hand gestures or facial gestures), a motion detector, or a microphone (possibly coupled to audio processing software to, e.g., detect voice commands). Suitable output devices include, but are not limited to, visual output devices, including displays, audio output devices, including speakers, headphones, earphones, and alarms, and haptic output devices.

The processor 1090 further may be coupled to a network interface device 1060. The network interface device 1060 prepares data generated by the processor 1090 for transmission via a network according to one or more data transmission protocols. The network interface device 1060 also decodes data received via a network according to one or more data transmission protocols. The network interface device 1060 can include a transmitter, receiver, or both. In other embodiments, the transmitter and receiver can be two separate components. The network interface device 1060, can be embodied as a general purpose processor, a digital signal processor (DSP), an application specific integrated circuit (ASIC), a field programmable gate array (FPGA) or other programmable logic device, discrete gate or transistor logic, discrete hardware components, or any suitable combination thereof designed to perform the functions described herein.

Such embodiments and further embodiments of the systems and methods described herein may advantageously improve the functioning of financial systems and computing devices by increasing the security for conducting electronic based payments. For example, previous financial systems and computing devices may be restricted to only being able to complete financial payment transactions through the exchange of sensitive information between customer devices and biller devices in order to maintain a particular level of ease of use for a customer. However, the systems and methods described herein may allow financial systems and computing devices to function without the transfer of such sensitive information while still maintaining a particular level of ease of use for a customer.

It should be noted that where reference is made herein to a device sending/transmitting to or receiving data or the like from another device, even if not explicitly stated, the other device, respectively, inherently receives from or sends/transmits the data or the like to the device. Further, and sending/transmitting or receiving may be performed over one or more networks, such as the Internet, and may be secured, such as using a virtual private network (VPN), encryption, and/or some other security protocols.

Various embodiments disclosed herein provide for electronically sending payment to a biller without transmitting certain sensitive information to the biller. A skilled artisan will readily appreciate that these embodiments may be implemented using numerous different types of computing devices, including both general purpose and/or special purpose computing systems, environments, or configurations. Examples of well-known computing systems, environments, and/or configurations that may be suitable for use in connection with the embodiments set forth above may include, but are not limited to, personal computers, server computers, hand-held or laptop devices, smartphones, multiprocessor systems, microprocessor-based systems, programmable consumer electronics, network PCs, minicomputers, mainframe computers, distributed computing environments that include any of the above systems or devices, and the like. These devices may include stored instructions, which, when executed by a microprocessor in the computing device, cause the computer device to perform specified actions to carry out the instructions. As used herein, instructions refer to computer-implemented steps for processing information in the system. Instructions can be implemented in software, firmware or hardware and include any type of programmed step undertaken by components of the system.

A microprocessor may be any conventional general purpose single- or multi-chip microprocessor such as a Pentium® processor, a Pentium® Pro processor, a 8051 processor, a MIPS® processor, a Power PC® processor, or an Alpha® processor. In addition, the microprocessor may be any conventional special purpose microprocessor such as a digital signal processor or a graphics processor. The microprocessor typically has conventional address lines, conventional data lines, and one or more conventional control lines.

Aspects and embodiments of the inventions disclosed herein may be implemented as a method, apparatus or article of manufacture using standard programming or engineering techniques to produce software, firmware, hardware, or any combination thereof. The term “article of manufacture” as used herein refers to code or logic implemented in hardware or non-transitory computer readable media such as optical storage devices, and volatile or non-volatile memory devices or transitory computer readable media such as signals, carrier waves, etc. Such hardware may include, but is not limited to, field programmable gate arrays (FPGAs), application-specific integrated circuits (ASICs), complex programmable logic devices (CPLDs), programmable logic arrays (PLAs), microprocessors, or other similar processing devices.

What is claimed is:

1. A system for improving security of computing devices used for financial payment transactions, the system comprising:
a memory; and
a processor coupled to the memory, the processor being configured to:
receive, via a computing device associated with a payer, biller data associated with a biller for a transaction between the payer and the biller;
determine availability of funds in one or more accounts associated with the payer for completing the transaction based on the received biller data;
receive a selection of one of the accounts having sufficient available funds to use for payment;
provide an indication to the biller, via the payer computing device, indicating the availability of funds; and
facilitate a transfer of at least a portion of the funds to the biller to complete the transaction without the computing device of the biller receiving sensitive information regarding the one or more accounts.

2. The system of claim 1, wherein the processor is further configured to receive identification information of the payer comprising at least one of a security token or an authorization code.

3. The system of claim 1, wherein the processor is further configured to send information indicating the at least the portion of the funds have been transferred to an account associated with the biller.

4. The system of claim 1, wherein the one or more accounts associated with the payer comprise a modified demand deposit account configured to debit funds from at least one of a traditional demand deposit account or a conjunctive credit line.

5. The system of claim 4, wherein the modified demand deposit account is configured to allocate to the transaction all or at least the portion of the funds in the modified demand deposit account before the information indicating the availability of funds is sent.

6. The system of claim 1, wherein the biller data comprises a cost of the transaction and an identifier of the transaction.

7. The system of claim 1, wherein the transfer of the at least the portion of the funds is performed via a bill payment.
